(19) United States
(12) Patent Application Publication
(10) Pub. No.: US 2023/0305534 A1
(43) Pub. Date: Sep. 28, 2023

(54) METHOD FOR RECOGNIZING AN OPERATING MODE OF A MACHINE TOOL, AND MACHINE TOOL

(71) Applicant: Hilti Aktiengesellschaft, Schaan (LI)

(72) Inventor: Tobias DREXL, Weil (DE)

(21) Appl. No.: 18/021,360

(22) PCT Filed: Aug. 3, 2021
(86) PCT No.: PCT/EP2021/071687

§ 371 Date: Feb. 14, 2023

(30) Foreign Application Priority Data
Aug. 17, 2020 (EP) 20191270.6

(51) Int. Cl. G05B 19/418

(52) U.S. Cl. CPC G05B 19/41825; G05B 2219/37134

(57) ABSTRACT

A method for recognizing an operating mode of a machine tool. A machine tool with a sensor for detecting axial accelerations and/or angular accelerations, wherein the machine tool is set up to carry out the proposed method.

The present invention relates to a method for recognizing an operating mode of a machine tool. In a further aspect, the invention relates to a machine tool with a sensor for detecting axial accelerations and/or angular accelerations, wherein the machine tool is set up to carry out the proposed method.

### BACKGROUND

Known in the prior art are machine tools which can be operated in both a stand-guided and a hand-guided manner. With the stand guide, the machine tool is attached to a so-called drill stand and therefore does not have to be held by hand when the machine tool is in operation. On the one hand, the user has his hands free, and on the other hand, the machine tool can be used for a longer period of time because the operation of the machine tool is not limited by the endurance and strength of the user. In the case of hand-guided applications, on the other hand, work can be performed more flexibly and variably. The stand mode and the manual mode are preferably referred to as operating modes of the machine tool in the context of the invention.

### SUMMARY OF THE INVENTION

Applications are conceivable for machine tools that can be used both in the stand-guided and in the hand-guided operation, in which different parameters are relevant, depending on whether the machine tool is used in the hand-guided operation or in the stand-guided operation. The behavior of a switch device on the machine tool can also vary depending on the operating mode (hand-guided or stand-guided). This can relate, for example, to a potentiometer function and/or a lockable switch of the machine tool.

It would of course be possible to determine whether the machine tool is operated in a stand-guided or a hand-guided manner by means of an additional (contact) sensor. The provision of a further sensor is, however, particularly undesirable in machine tools that are operated on construction sites, because this creates opportunities for dust and/or moisture to come in. Moreover, the provision of a further sensor increases the complexity of the system, which is also undesirable.

An object of the present invention is to provide a method for recognizing an operating mode of a machine tool by way of which the operating mode of the machine tool can preferably be recognized automatically so that different functionalities can be displayed and/or offered to the user, depending on the recognized operating mode. The operating mode here is to be recognized in particular without the provision of a further sensor, so that a particularly robust machine tool that is suitable for construction sites can be provided for carrying out the method. It would be particularly desirable if existing data and measured values could be used in the process or the underlying data evaluation, respectively.

The present invention provides a method for recognizing an operating mode of a machine tool. The method is characterized in that axial accelerations and angular accelerations are detected by a sensor and used as a basis for determining a deflection of the machine tool, wherein the deflection determined is able to be assigned to different operating modes of the machine tool. The operating modes of the machine tool are preferably the “manual operation” and the “stand operation” operating modes. In the context of the invention, these operating modes can be referred to as the first and the second operating mode of the machine tool. In the proposed method, the determined deflection of the machine tool can preferably be assigned to a first operating mode or a second operating mode of the machine tool.

The assignment of the determined values for the axial and the angular acceleration to an operating mode is made possible in particular by the differently large deflections of the machine tool, which occur or can be measured, respectively, in the different operating modes in particular when the machine tool is started. In this case, large deflection values are assigned, in particular, to the “manual operation” operating mode, while smaller deflection values are assigned to the “stand operation” operating mode. In this way, by determining the axial and angular accelerations along the axes of a coordinate system, which can be used to effectively determine the deflection when the machine tool is switched on, it can be effectively determined whether the machine tool is operated in the manual operation or in the stand operation. In other words, the deflection of the machine tool can be determined by the measured values determined by the sensor for detecting axial accelerations and/or angular accelerations and used as the basis for identifying the operating mode of the machine tool.

In the context of the invention, it is preferred that the sensor is present so as to be disposed on the machine tool. Moreover, it is preferred that the deflection of the machine tool, or the underlying accelerations, respectively, are detected when switching on the machine tool. In other words, a preferred embodiment of the proposed method is characterized in that the axial accelerations and the angular accelerations can be detected by a sensor on the machine tool and used as a basis for determining the deflection when switching on the machine tool, wherein the deflection determined is able to be assigned to a first operating mode or to a second operating mode of the machine tool.

In a preferred design embodiment, the method can comprise the following steps
a) providing a machine tool with a sensor for recording axial accelerations and/or angular accelerations,
b) determining axial accelerations a1, a2 and a3 along a first, second and third axis of an imaginary coordinate system,
c) determining angular accelerations w1, w2 and w3 along the first, second and third axes of the imaginary coordinate system,
d) determining a first angle of rotation alpha, a second angle of rotation beta and a third angle of rotation gamma about the three axes,
e) determining a first, second and third angle of rotation acceleration,
f) deriving an operating mode of the machine tool from the angle of rotation accelerations determined under e).

The sensor for detecting axial accelerations and/or angular accelerations can preferably be a gyro sensor. The invention is based on the inventor's knowledge that the rotational accelerations along the three axes of an imaginary coordinate system differ considerably when a machine tool is started, depending on whether the machine tool is operated in manual mode or in stand mode. The inventor has recognized that due to the inertia of the drilling system, which preferably comprises a motor, a shaft, a gear and a tool, a deflection when starting the motor in the manual operation is significantly greater than the deflection in the drill stand. This is particularly because the machine tool is present so as to be screw-fitted into the drill stand. The different deflections when switching on the motor of the machine tool can therefore be used to identify an operating mode of the machine tool in an effective and in particular error-free manner, specifically in accordance with the proposed method. The deflection of the machine tool in the manual operation preferably takes place around a hand axis. The expression “recognition of the operating mode of a machine tool” in the context of the invention is synonymous with the fact that the proposed method is used to recognize whether the machine tool is being used in the manual operation or in the stand operation. The operation of the machine tool can be adapted to the recognized operating mode as a result of the preferably automatic operating mode recognition. This can take place, for example, in that different functionalities or parameters as a function of the recognized operating mode are displayed or offered for selection to the user of the machine tool on a display device.

In particular, the proposed method can be carried out using a machine tool, wherein the machine tool comprises a sensor for detecting axial accelerations and/or angular accelerations by way of three axial acceleration axes and three rotational acceleration axes. The sensor can be designed as a gyro sensor, for example. In other words, the gyro sensor of the machine tool is set up to measure axial accelerations and rotational accelerations along three spatial axes. The proposed method includes, in particular, those method steps which enable the angular accelerations to be determined in the three spatial axes, as well as an assignment of the results to one of the two operating modes “stand operation” or “manual operation”.

It is preferred in the context of the invention that the measured variables can be compared with stored values while using suitable filters or using a suitable filter selection and conversions, respectively, in order to be able to reliably assign the results to one of the two operating modes. In particular, the invention also relates to a computer program product that can be operated on the machine tool. To this end, the machine tool can preferably comprise a processor and/or a control installation, as well as means for storing data and measured values. For example, databases with values for the angle of rotation acceleration values can be stored in the storage means, which can preferably be used to enable the measurement values to be assigned to the operating modes. However, it can also be preferable for the machine tool to have communication means that enable the machine tool to access a cloud or a server if the comparison values for determining the operating mode of the machine tool are stored in a cloud or on a server.

In the context of the invention, it is preferred that the machine tool can be operated in different operating modes. For example, the machine tool can be operated so as to be guided by a stand or by hand. Depending on the mode of operation, different parameters can be relevant to operation. For example, tipping points on the motor characteristic can be switched over depending on the operating mode of the machine tool. Tests have shown that the drill stand can absorb more torque than is the case with manual operation of the machine tool. Moreover, the motor characteristics or the profile of the latter, respectively can also depend on the selected motor type, since, for example, with brushless motors, such as asynchronous machines, different breakdown characteristics can be used than with other motor types. In the context of the invention, it is preferred that the machine tool reacts more slowly in the manual operation than in the stand operation. In other words, the proposed machine tool is designed to be more sluggish in the manual operation than in the stand operation. Moreover, the different parameters depending on the operating mode of the machine tool can lie in that additional functions are enabled, for example, such as an automatic feed device, such as an autofeed device, for example. In the context of the invention, it is preferred that a feed device is used in particular in the stand operation of the machine tool.

In the context of the invention it is preferred that the varying parameters can be displayed on the machine tool. To this end, the machine tool can comprise corresponding display means, such as a display, a monitor or a screen, for example. A touchscreen is also conceivable. It can moreover be preferred that a user of the machine tool can set the different parameters, depending on the operating mode in which the machine tool is operated. Such a setting of parameters can, however, also take place automatically in the context of the present invention, in particular as a function of the determined operating mode of the machine tool. It is within the context of the invention that the invention can be used to switch over a display means, such as a display. For example, when the machine tool is operated in the different operating modes—for example in the stand operation and the manual operation—different types of information can be relevant for the user. In the case of the stand operation, information relating to the feed device can be displayed, for example, said information being irrelevant when the machine tool is operated in the manual operation, because a feed device is not used in this instance. For example, a spirit level function can be relevant for the user in particular when the machine tool is in the manual operation, while a power display is particularly relevant in the stand operation.

In the context of the invention it is preferred that a behavior, or a design embodiment, respectively, of a switching device of the machine tool can vary as a function of the operating mode of the machine tool. For example, an on/off switch, which is preferably to be switched in a binary manner, can be particularly useful in the stand operation, while in the manual operation of the machine tool a speed specification can be useful, which can be provided, for example, by a potentiometer function. In a preferred embodiment of the invention, a switch lock can be provided. This embodiment is particularly preferred in the “stand operation” mode.

The proposed method comprises the determination of axial accelerations a1, a2 and a3 along a first, second and third axis of an imaginary coordinate system. The imaginary coordinate system can preferably be a known Cartesian coordinate system with an x, y and z axis. A potential disposal of axes of this imaginary coordinate system is shown in FIG. 1. For example, the x-axes can run in the horizontal direction and the z-axis in the vertical direction, while the y-axis protrudes from the plane of the paper. In the context of the invention it is preferred that the first axis represents an x-axis of the imaginary coordinate system, the second axis represents a y-axis, and the third axis represents a z-axis. It is further preferred that the first, second and third axes coincide with axes of the machine tool or correspond to said axes of the machine tool, respectively.

For example, the sensor for detecting axial accelerations and/or angular accelerations can be disposed in the electronics area, for example on a printed circuit board. The sensor can preferably also be disposed in the area of a human machine interface (HMI). Tests have shown that the mentioned positions of the sensor are particularly suitable for determining the axial accelerations and the angle of rotation accelerations. In the context of the invention, it is preferred to select a reference axis of the coordinate system such that the drilling axis is used as the z-axis of the coordinate system.

In the context of the invention, it is preferred to use the reference sign a1 to describe the axial acceleration of the machine tool in the direction of the first axis, i.e. preferably in the direction of the x-axis. In an analogous manner, in the context of the invention it is preferred to use the reference sign a2 to describe the axial acceleration of the machine tool in the direction of the second axis, i.e. preferably in the direction of the y-axis, or the reference sign a3 to describe the axial acceleration of the machine tool in the direction of the third axis, i.e. preferably in the direction of the z-axis.

The machine tool preferably also has an angular acceleration by way of which the machine tool rotates about the three axes. Preferably, w1 describes the angular acceleration about the first, i.e. the x-axis. In an analogous manner, w2 describes the angular acceleration about the second, i.e. the y-axis, while w3 describes the angular acceleration about the third, i.e. the z-axis.

In a next method step, the angles of rotation about the respective axes can be determined from the data sets ai and wi for the axial acceleration and the angular acceleration, respectively. This can take place, for example, by means of suitable mathematical integration methods.

In the context of the invention, these are preferably referred to as the first angle of rotation alpha, the second angle of rotation beta, and the third angle of rotation gamma.

In a further method step, the operating mode of the machine tool is determined on the basis of the previously determined axial and angle of rotation accelerations. To this end, the deflection of the machine tool when switching on the latter is determined on the basis of the detected acceleration data. The deflection determined can then be assigned to a first or a second operating mode, wherein large deflections, for example, may represent a manual operation of the machine tool and small deflection values may represent a stand operation.

In the context of the invention it is preferred that the method can include an additional method step, specifically the display of different objects on a display device of the machine tool as a function of the recognized operating mode of the machine tool. The objects displayed can be different images, modes and/or (operating) parameters that are relevant to one of the two operating modes, i.e. hand-guided or stand-guided. It may also be that there are display objects that are relevant to both operating modes of the machine tool. These can then preferably also be displayed in both operating modes. In the context of the invention it is preferred that the machine tool comprises a display device for displaying the different objects, depending on the operating mode. These can be known display devices such as displays, monitors or screens, wherein the screens can also be designed, for example, as touch-sensitive screens that can receive inputs when a user of the machine tool touches them.

For the purposes of the invention, it is preferred that the data ascertained with the method can be used to determine if a slip clutch release event has occurred. In other words, the data can be used to find out whether a slip clutch of the machine tool has released.

In a second aspect, the invention relates to a machine tool which has a sensor for detecting axial accelerations and/or angular accelerations, wherein the machine tool is set up to carry out the proposed method. In the context of the invention it is preferred that the sensor is a gyro sensor. The terms, technical effects and advantages introduced for the proposed method apply in an analogous manner to the machine tool by way of which the method can be carried out.

Further advantages of the invention will become apparent from the following description of the figures. An exemplary embodiment of the present invention is illustrated in the figure. The figure, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs. In the figures:

FIG. 1 shows a potential sequence of a preferred embodiment of the proposed method

### DETAILED DESCRIPTION

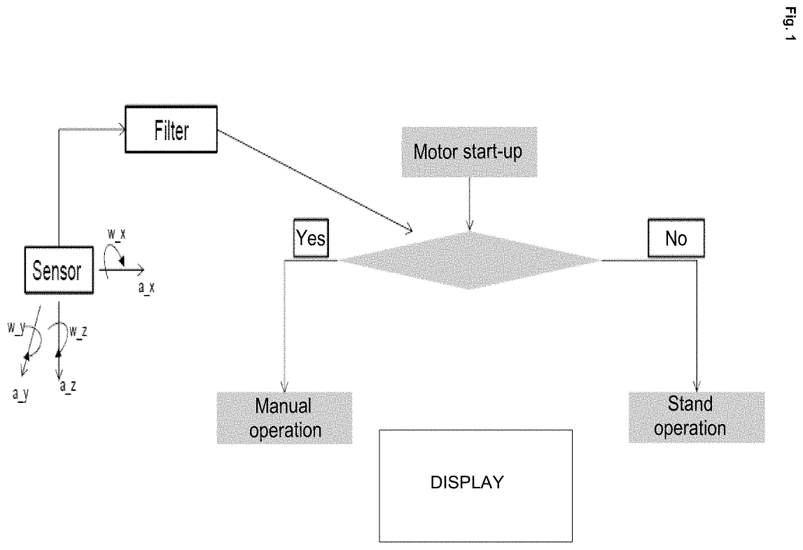

FIG. 1 shows a potential sequence of a preferred embodiment of the proposed method. First, various acceleration values are detected by a sensor. These here can be the accelerations along the three coordinate axes of a coordinate system. In the context of the invention, these accelerations are referred to as “axial accelerations”. They are illustrated in FIG. 1 as accelerations a_x, a_y and a_z. Moreover, angular accelerations can be measured with the sensor. These here can be the angular accelerations about the three coordinate axes of the coordinate system. The angular accelerations are illustrated in FIG. 1 as accelerations w_x, w_y and w_z. The data detected by the sensor can be filtered and evaluated, for example, by a control device of the machine tool. The evaluation includes, for example, the determination of the deflection of the machine tool when switching on the latter, as well as an assignment of this determined deflection to an operating mode of the machine tool. The operating modes of the machine tool can preferably be a manual operation as the first operating mode and a stand operation as the second operating mode. A large deflection of the machine tool at start-up can be interpreted, for example, as the manual operation of the machine tool (shown in FIG. 1 as “Yes”), while a small deflection of the machine tool at start-up can be interpreted as the stand operation of the machine tool (shown in FIG. 1 as “No”).

What is claimed is:

1-9. (canceled)

10. A method for recognizing an operating mode of a machine tool, the method comprising:
detecting axial accelerations and angular accelerations using a sensor; and
using the detected axial accelerations and angular accelerations as a basis for determining a deflection of the machine tool, wherein the deflection determined is able to be assigned to different operating modes of the machine tool.

11. The method as recited in claim 10 further comprising:
providing a machine tool with the sensor;
the detecting step including: determining axial accelerations along a first, second and third axis of an imaginary coordinate system, determining angular accelerations along the first, second and third axes of the imaginary coordinate system, and determining a first angle of rotation, a second angle of rotation and a third angle of rotation about the first, second and third axes, respectively; and
deriving one of the different operating modes of the machine tool via a deflection determined from accelerations of the first, second and third angles of rotation.

12. The method as recited in claim 10 further comprising displaying different objects on a display device of the machine tool as a function of the derived operating mode of the machine tool.

13. The method as recited in claim 10 wherein the axial accelerations and angular accelerations are used to determine if a slip clutch release event has occurred.

14. The method as recited in claim 10 wherein the first axis represents an x-axis of the imaginary coordinate system, the second axis represents a y-axis, and the third axis represents a z-axis.

15. The method as recited in claim 10 wherein the sensor is a gyro sensor.

16. A machine tool comprising the sensor for detecting axial accelerations for angular accelerations for carrying out the method as recited in claim 10.

17. The machine tool as recited in claim 10 wherein the machine tool includes a display device.

18. The machine tool as recited in claim 16 wherein the sensor is a gyro sensor.

19. A method for recognizing an operating mode of a machine tool, the method comprising:
a) providing a machine tool with a sensor for recording axial accelerations or angular accelerations,
b) determining axial accelerations along a first, second and third axis of an imaginary coordinate system,
c) determining angular accelerations along the first, second and third axes of the imaginary coordinate system,
d) determining a first angle of rotation, a second angle of rotation and a third angle of rotation about the first, second and third axes, respectively,
e) deriving an operating mode of the machine tool from accelerations of the first, second and third angles of rotation.
